(19) United States
(12) Patent Application Publication
(10) Pub. No.: US 2013/0054599 A1
(43) Pub. Date: Feb. 28, 2013

(54) Dynamically Generated List Index

(71) Applicant: Roderic Wells Lewis, JR., Maple Valley, WA (US)

(72) Inventor: Roderic Wells Lewis, JR., Maple Valley, WA (US)

(73) Assignee: MICROSOFT CORPORATION, Redmond, WA (US)

(21) Appl. No.: 13/223,141

(22) Filed: Aug. 31, 2011

(51) Int. Cl. G06F 17/30

(52) U.S. Cl. 707/737; 707/E17.002; 707/E17.046

(57) ABSTRACT

Dynamically generated lists are provided. Data elements may be sorted in a list according to a value. An index may be dynamically generated to divide the data elements into one or more index groupings, the index groupings containing an equal or nearly-equal number of data elements. The index may comprise index grouping entry points allowing for navigation to each of the one or more index groupings. If a list is modified, for example a data element is added, removed, or otherwise modified, the index may be automatically regenerated to preserve equal distribution of data elements across the index groupings.

### BACKGROUND

In today's digital age, computers are increasingly being used to store and manipulate various types of information. Oftentimes in a computing environment, there is a need to organize data into lists. A list may be composed of various types of data. It may be desirable to divide contents of a list into sections or indices. For example, a list may be provided in a webpage and may contain a large number of rows of data. A single page containing such a large list may be inefficient to download as well as difficult to navigate. To help with organization, efficiency and user-friendly navigation, a plurality of index groupings may be generated across a list, and data may be distributed among the index groupings. For example, a list may be comprised of names that may be sorted alphabetically by last name and indexed by the first letter of the last name.

A shortcoming of conventional indexing is that index groupings may contain various amounts of data. Referring back to the example above, an alphabetical list of names may comprise a large number of names under “B” but may only contain one entry under “Q.” It may be desirable for each index grouping to contain a similar amount of data. Additionally, many lists may be populated by user-generated content. As data is added to or removed from a list, the list's index groupings may be unbalanced wherein one index grouping may contain a large amount of data and another index grouping may contain no or only a few rows of data.

It is with respect to these and other considerations that the present invention has been made.

### SUMMARY

Embodiments of the present invention solve the above and other problems by providing a dynamic index comprised of data elements sorted according to a value and equally distributed among one or more index groupings.

According to embodiments, data elements may be sorted in a list according to a value. For example, a list may be a list of songs and the songs may be arranged in alphabetical order by song title. An index may be dynamically generated to divide the data elements into one or more index groupings, each index grouping containing an equal or nearly-equal number of data elements. The index may comprise index grouping entry points allowing for navigation to each of the one or more index groupings. If a list is modified, for example a data element is added, removed, or otherwise modified (e.g., the spelling of a data element is changed), the index may be automatically regenerated to preserve equal distribution of data elements across the index groupings.

The details of one or more embodiments are set forth in the accompanying drawings and description below. Other features and advantages will be apparent from a reading of the following detailed description and a review of the associated drawings. It is to be understood that the following detailed description is explanatory only and is not restrictive of the invention as claimed.

This summary is provided to introduce a selection of concepts in a simplified form that are further described below in the detailed description. This summary is not intended to identify key features or essential features of the claimed subject matter, nor is it intended as an aid in determining the scope of the claimed subject matter.

### BRIEF DESCRIPTION OF THE DRAWINGS

The accompanying drawings, which are incorporated in and constitute a part of this disclosure, illustrate various embodiments of the present invention. In the drawings:

FIG. 1 is a block diagram illustrating an example list containing a plurality of data elements, an index, and an index grouping;

FIG. 2 is a simplified block diagram illustrating an example of various index groupings containing varying amounts of data elements using previous indexing methods;

FIG. 3 is a simplified block diagram illustrating an example of a dynamically generated index and equally distributed data elements into index groupings according to an embodiment;

FIG. 4 is a simplified block diagram illustrating an example of a modified list and a regenerated index, index grouping, and index grouping entry points;

FIG. 5 is a process flow diagram illustrating an example process of generating a dynamic index;

FIG. 6 is a block diagram illustrating example physical components of a computing device with which embodiments of the invention may be practiced;

FIG. 7A and 7B are simplified block diagrams of a mobile computing device with which embodiments of the present invention may be practiced; and

FIG. 8 is a simplified block diagram of a distributed computing system in which embodiments of the present invention may be practiced.

### DETAILED DESCRIPTION

As briefly described above, embodiments of the present invention are directed to generating a dynamic index. According to embodiments, a list comprising a plurality of data elements may be provided. The plurality of data elements may be ordered according to a classification, for example, alphabetically. The plurality of data elements may be grouped into one or more index groupings, for example, grouped according to a letter of the alphabet. The one or more index groupings may be individually selected and accessed by a user via a selection of the index grouping from an index. The index may comprise a plurality of index grouping entry points representing the one or more index groupings.

According to one embodiment, the list of data elements may be automatically grouped into index groupings of equal numbers of data elements and the index may be automatically generated to represent the index groupings. If the list is modified, for example, a data element is added or removed, the data elements may be automatically redistributed into index groupings to maintain equally-sized index groupings. Accordingly, the index may be automatically regenerated to represent the reorganized data elements.

The following description refers to the accompanying drawings. Whenever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

Referring now to the drawings, in which like numerals represent like elements through the several figures, aspects of the present invention and the exemplary operating environment will be described. While the invention will be described in the general context of program modules that execute in conjunction with an application program that runs on an operating system on a personal computer, those skilled in the art will recognize that the invention may also be implemented in combination with other program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

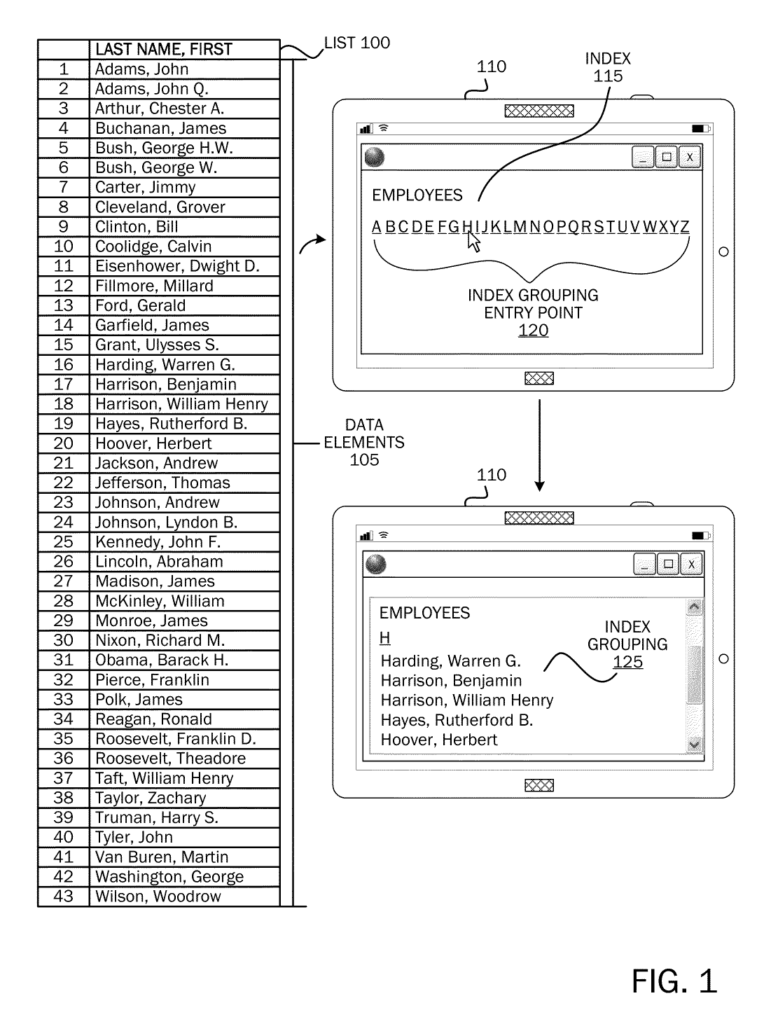

FIG. 1 is a simplified block diagram illustrating a list 100. The list 100 is contains a plurality of data elements 105. A data element 105 may be a text element, a numeric element, or any other type of data element that can be arranged in a list 100 according to a classification. For example and as illustrated in FIG. 1, data element 105 may be a name. As mentioned previously, data elements 105 may be arranged in a list according to a classification. A classification may include, for example, alphabetical order, numeric order, etc. According to embodiments, data elements 105 in a list 100 may be grouped into one or more index groupings 125. An index grouping 125 may be a grouping corresponding to a classification. For example and as shown in FIG. 1, data elements 105 of an alphabetized list of names 100 may be grouped into index groupings 125 according to the first letter of the last name. As shown in FIG. 1, five names beginning with the letter “H” are categorized into an index grouping 125 “H”.

According to embodiments, an index 115 may be provided, the index containing a plurality of entry points, hereafter referred to as index grouping entry points 120, allowing for navigation to a corresponding index grouping 125. An index grouping entry point 120 may be text, numbers, symbols, etc. representing an index grouping 125. The index grouping entry point 120 may be selectable. Upon selection of an index grouping entry point 120, the corresponding data elements 105 of the index grouping 125 represented by the index grouping entry point 120 may be accessed/displayed. According to an embodiment, the corresponding data elements 105 may be displayed in a separate window. According to another embodiment, upon selection of an index grouping entry point 120, the display may be automatically scrolled down to the corresponding data elements 105, which may be included on the same page as the index.

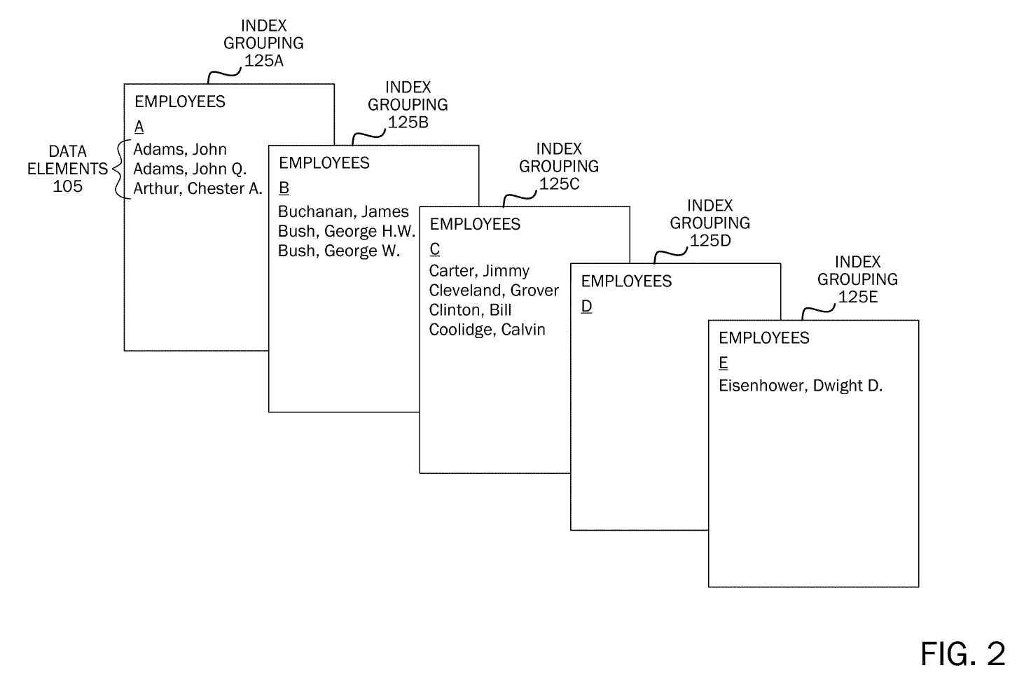

Current indexing methods may use a static index wherein data elements 105 are classified into data element groups 125 that may contain varying numbers of data elements. For example, as illustrated in the simplified block diagram in FIG. 2, index grouping 125D contains no data elements 105 since there are no data elements in the list 100 in FIG. 1 that are represented by the classification of the index grouping 125D. That is, the list 100 does not contain any names wherein the last name begins with the letter “D”. However, index grouping 125C contains four data elements 105 since there are four data elements 125 in the list 100 in FIG. 1 that are represented by the classification “C” of the index grouping 125C. As can be appreciated, having varying sized index groupings 125 may be undesirable. For example, if a webpage displaying a index grouping 125 containing a large number of data elements 105 may require for the page to be a different size than another page displaying a index grouping 125 containing a few number of data elements 105.

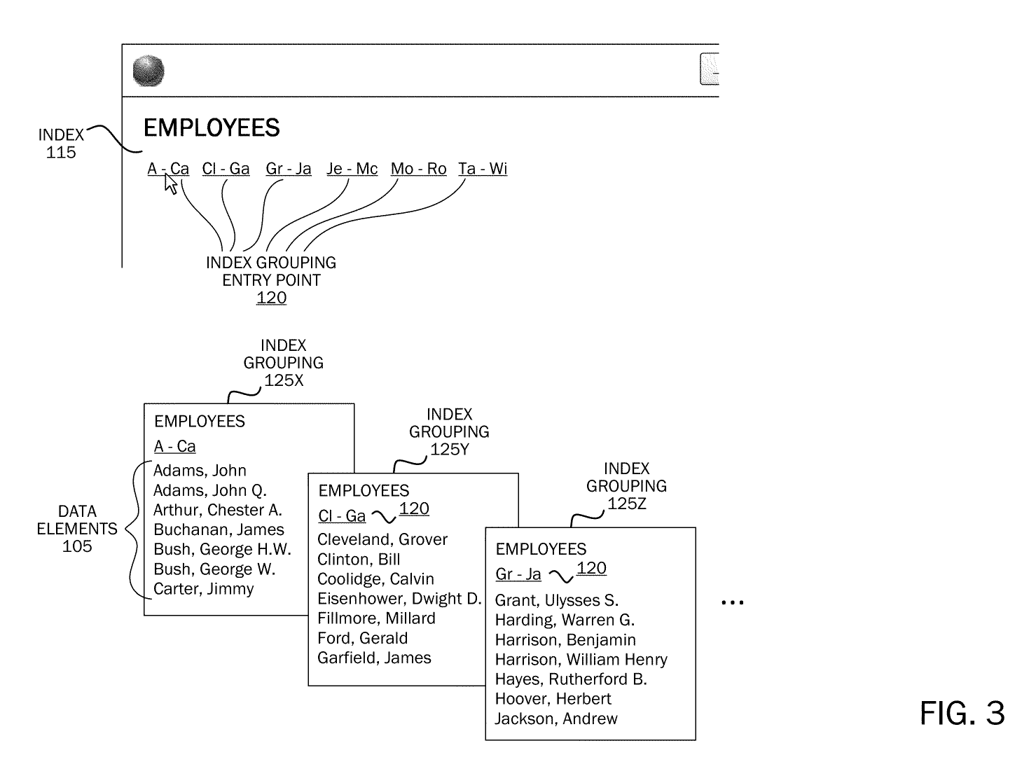

According to an embodiment, index groupings 125 and associated index entry points 120 may be dynamically generated so that index groupings 125 contain an evenly distributed or nearly-evenly distributed number of data elements 105. For example, and as shown in the simplified block diagram illustrated in FIG. 3, when utilizing a dynamically generated index, index groupings 125X, 125Y, 125Z may contain an equal amount of data elements 105. For example index groupings 125X, 125Y, 125Z each contain seven names (data elements 105). Data elements 105 may be automatically categorized into index groupings 125X, 125Y, 125Z according to a new classification so that the data elements are evenly distributed across index groupings. For example, as shown in FIG. 2, utilizing previous indexing methods, index grouping 125A is classified by last names beginning with the letter “A”. Alternatively, utilizing methods according to embodiments and as shown in FIG. 3, index grouping 125X is classified by last names beginning with a letter between “A” and “Ca”, index grouping 125Y is classified by last names beginning with a letter between “Cl” and “Ga”, and index grouping 125Z is classified by last names beginning with a letter between “Gr” and “Ja”.

According to embodiments, the index 115 may be automatically generated so that the index grouping entry points 120 are representative of the newly distributed data elements 105 of the dynamically generated index groupings 125X, 125Y, and 125Z.

As shown in FIG. 3, the index 115 now contains index entry points 120: “A-Ca”, “Cl-Ga”, “Gr-Ja”, “Je-“Mc”, “Mo-Ro”, and “Ta-Wi”.

According to previous indexing methods, as data 105 is added to or removed from a list 100 or otherwise modified, index groupings 125 may be unbalanced and contain various amounts of data elements. According to an embodiment, when a data element 105 is added to a list 100, removed from a list 100, or modified so that it may be recategorized into a different index grouping 125, the index 115, index groupings 125, and index grouping entry points 120 may be automatically and dynamically generated so that the data elements 105 are evenly distributed among a plurality of index groupings 125.

According to one embodiment, the number of index groupings 120 may be fixed. According to this scenario, the data elements 105 may be evenly divided into the given number of index grouping entry points 120. For example, if a list 100 originally contains one hundred data elements 105 distributed among a fixed number of ten index groupings 125, and ten additional data elements 105 are added to the list 100, the now one hundred ten data elements 105 will be distributed among the ten index groupings 125 with eleven data elements 105 in each index grouping 125.

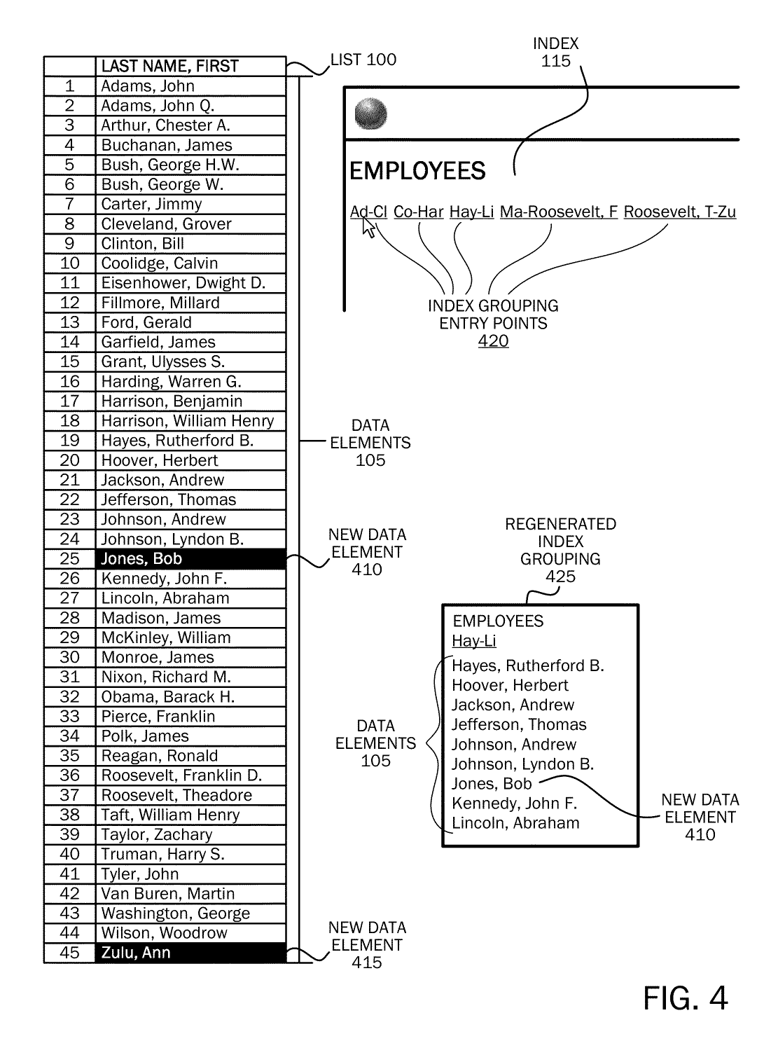

According to an embodiment, a range of data elements 105 within each of a plurality of index groupings 125 may be modified if data elements 105 are added to a list 100, removed from a list 100, or otherwise modified (e.g., a person's last name changes, and the data element (last name) is modified to reflect the change). For example, and with reference now to FIG. 4, in the list 100, two names have been added: Bob Jones 410 and Ann Zulu 415. Upon a detection of this data change, the index 115 may be regenerated so that the now forty-five data elements 105 are evenly distributed among updated index groupings 425. In this example, before the new data elements 410,415 were added, the data elements were grouped into index groupings 125 as follows: “A-Ca”, “Cl-Ga”, “Gr-Ja”, “Je-Mc”, “Mo-Ro”, and “Ta-”Wi“. According to embodiments, upon detection of the two new data elements 410,415, the index 115 may be regenerated and a regenerated index grouping 425 may contain a new set of data elements 105,410,415. For example, an updated index grouping 425 may now contain nine names (data elements 105,410) representing names beginning with “Hay” through names beginning with “Li”. Accordingly, index grouping entry points 420 may be regenerated to represent the regenerated index groupings 125 as illustrated in FIG. 4.

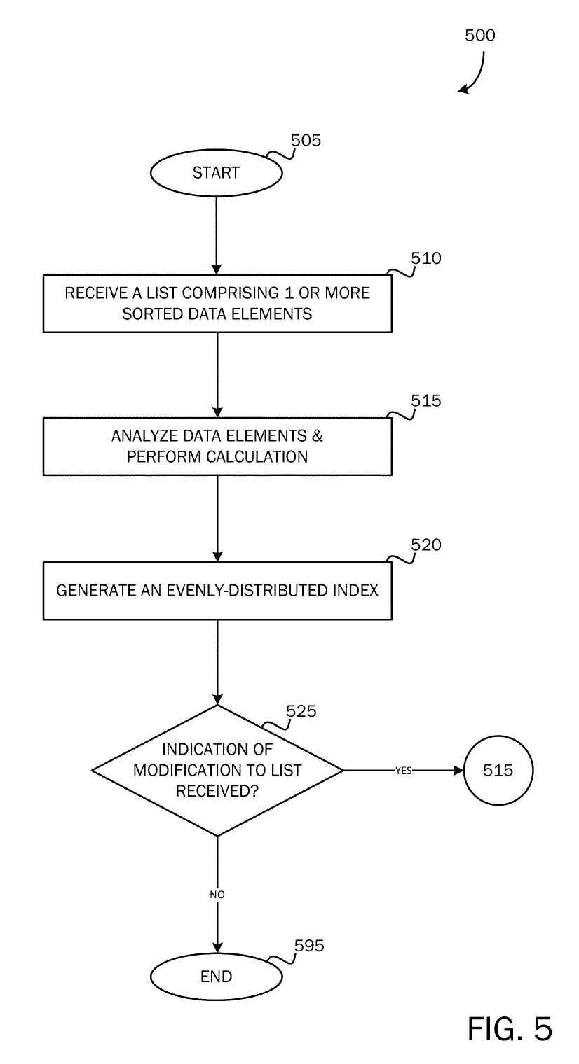

FIG. 5 is a flow diagram illustrating a process 500 of dynamically generating an index according to an embodiment. The process starts at OPERATION (505), and proceeds to OPERATION (510) where a list 100 comprising one or more sorted data elements 105 is received. As previously described, the one or more data elements may include text or numerical data, and may be sorted by a value, for example, a list 100 of names of people listed in alphabetical order by last name.

The process 500 proceeds to OPERATION (515) where the data elements 105 are analyzed and a calculation is performed to categorize the data elements into one or more index groupings 125. According to one embodiment, an index 115 may be limited to a fixed number of data elements 105 per index grouping 125, wherein the number of index groupings may vary. According to another embodiment, an index 115 may be limited to a fixed number of index groupings 125, wherein the number of data elements 105 in an index grouping may vary. According to another embodiment, no specifications limiting an index grouping 125 size or a number of index groupings may be received.

According to embodiments, an algorithm may be utilized to calculate a distribution of data elements 105 into index groupings 125. For example, according to one embodiment, if an index 115 is limited to a fixed number of data elements 105 per index grouping 125, wherein the number of index groupings may vary, an example algorithm like the algorithm set out below may be utilized.

While not EOL{

Index [i] = First two characters of (current IndexValue)
Index += data elements per index grouping

}

For example, according to another embodiment, if an index 115 is limited to a fixed number of index groupings 125 in the index 115, wherein the number of data elements 105 in an index grouping may vary, an example algorithm like the algorithm set out below may be utilized.

While not EOL{

Index [i] = First two characters of (current IndexValue)
Index += (total data element count)/(number of index groupings)

}

After the data elements 105 are analyzed and a calculation is performed (515), an evenly-distributed index 115 may be generated (520). That is, data elements 105 may be distributed into one or more index groupings 125, and may be distributed according to a fixed index grouping size or a fixed number of index groupings.

At DECISION OPERATION (525), if an indication is not received of a modification to the list 100, the process 500 ends at OPERATION (595). A modification to the list 100 may include an addition of one or more data elements 105, a removal of one or more data elements, or another type of modification, for example, a change to a data element. Alternatively, if an indication of a modification to the list 100 is received, the process 500 proceeds back to OPERATION (515) where the data elements 105 of the list may be reanalyzed and a calculation may be made to regenerate an updated evenly-distributed index 115 (520). The process ends at OPERATION (595).

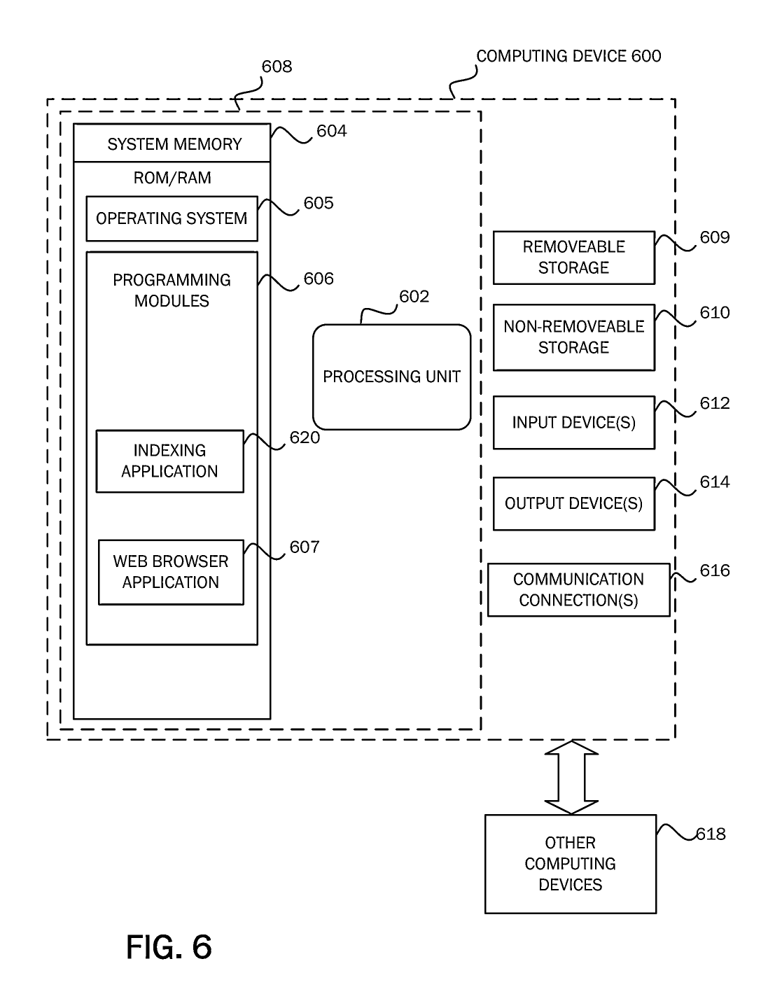

The embodiments and functionalities described herein may operate via a multitude of computing systems, including wired and wireless computing systems, mobile computing systems (e.g., mobile telephones, tablet or slate type computers, laptop computers, etc.). In addition, the embodiments and functionalities described herein may operate over distributed systems, where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like. FIGS. 6-8 and the associated descriptions provide a discussion of a variety of operating environments in which embodiments of the invention may be practiced. However, the devices and systems illustrated and discussed with respect to FIGS. 6-8 are for purposes of example and illustration and are not limiting of a vast number of computing device configurations that may be utilized for practicing embodiments of the invention, described herein.

FIG. 6 is a block diagram illustrating example physical components of a computing device 600 with which embodiments of the invention may be practiced. In a basic configuration, computing device 600 may include at least one processing unit 602 and a system memory 604. Depending on the configuration and type of computing device, system memory 604 may comprise, but is not limited to, volatile (e.g. random access memory (RAM)), non-volatile (e.g. read-only memory (ROM)), flash memory, or any combination. System memory 604 may include operating system 605, one or more programming modules 606, and may include an indexing application 620. Operating system 605, for example, may be suitable for controlling computing device 600's operation. Furthermore, embodiments of the invention may be practiced in conjunction with a graphics library, other operating systems, or any other application program and is not limited to any particular application or system. This basic configuration is illustrated in FIG. 6 by those components within a dashed line 608.

Computing device 600 may have additional features or functionality. For example, computing device 600 may also include additional data storage devices (removable and/or non-removable) such as, for example, magnetic disks, optical disks, or tape. Such additional storage is illustrated in FIG. 6 by a removable storage 609 and a non-removable storage 610.

As stated above, a number of program modules and data files may be stored in system memory 604, including operating system 605. While executing on processing unit 602, programming modules 606, such as an indexing application 620 may perform processes including, for example, one or more method 500's operations as described above. The aforementioned process is an example, and processing unit 602 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. For example, embodiments of the invention may be practiced via a system-on-a-chip (SOC) where each or many of the components illustrated in FIG. 6 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to indexing application 620 may be operated via application-specific logic integrated with other components of the computing device/system 600 on the single integrated circuit (chip). Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process.

The term computer readable media as used herein may include computer storage media. Computer storage media may include volatile and nonvolatile, removable and non-removable media implemented in any method or technology for storage of information, such as computer readable instructions, data structures, program modules, or other data. System memory 604, removable storage 609, and non-removable storage 610 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 600. Any such computer storage media may be part of device 600. Computing device 600 may also have input device(s) 612 such as a keyboard, a mouse, a pen, a sound input device, a touch input device, etc. Output device(s) 614 such as a display, speakers, a printer, etc. may also be included. The aforementioned devices are examples and others may be used.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

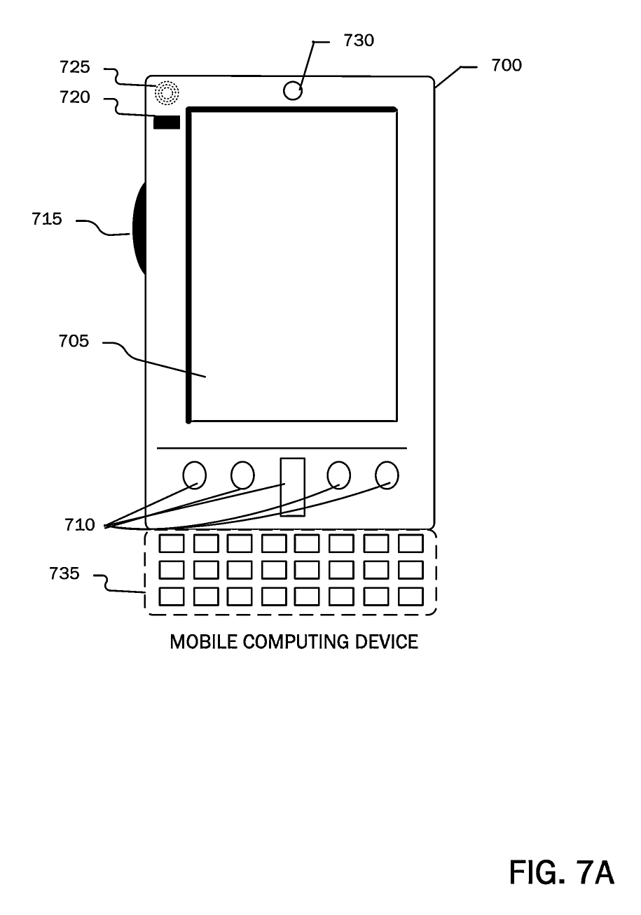

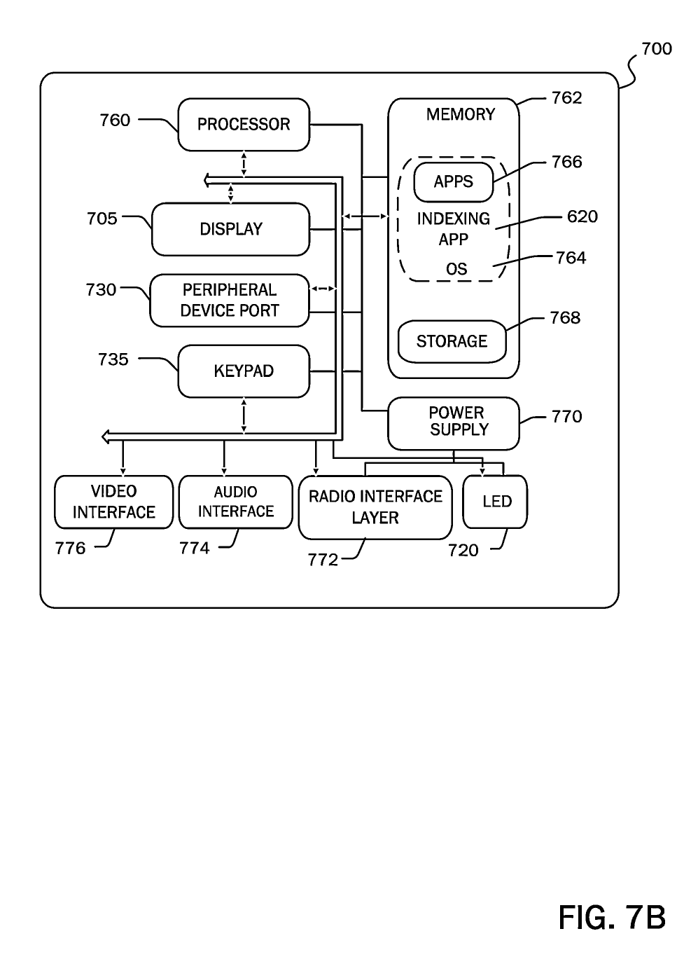

FIGS. 7A and 7B illustrate a suitable mobile computing environment, for example, a mobile telephone 700, a smartphone, a tablet personal computer 110, a laptop computer, and the like, with which embodiments of the invention may be practiced. With reference to FIG. 7A, an example mobile computing device 700 for implementing the embodiments is illustrated. In a basic configuration, mobile computing device 700 is a handheld computer having both input elements and output elements. Input elements may include touch screen display 705 and input buttons 715 that allow the user to enter information into mobile computing device 700. Mobile computing device 700 may also incorporate an optional side input element 715 allowing further user input. Optional side input element 715 may be a rotary switch, a button, or any other type of manual input element. In alternative embodiments, mobile computing device 700 may incorporate more or less input elements. For example, display 705 may not be a touch screen in some embodiments. In yet another alternative embodiment, the mobile computing device is a portable phone system, such as a cellular phone having display 705 and input buttons 715. Mobile computing device 700 may also include an optional keypad 735. Optional keypad 735 may be a physical keypad or a “soft” keypad generated on the touch screen display.

Mobile computing device 700 incorporates output elements, such as display 705, which can display a graphical user interface (GUI). Other output elements include speaker 725 and LED light 720. Additionally, mobile computing device 700 may incorporate a vibration module (not shown), which causes mobile computing device 700 to vibrate to notify the user of an event. In yet another embodiment, mobile computing device 700 may incorporate a headphone jack (not shown) for providing another means of providing output signals.

Although described herein in combination with mobile computing device 700, in alternative embodiments the invention is used in combination with any number of computer systems, such as in desktop environments, laptop or notebook computer systems, multiprocessor systems, micro-processor based or programmable consumer electronics, network PCs, mini computers, main frame computers and the like. Embodiments of the invention may also be practiced in distributed computing environments where tasks are performed by remote processing devices that are linked through a communications network in a distributed computing environment; programs may be located in both local and remote memory storage devices. To summarize, any computer system having a plurality of environment sensors, a plurality of output elements to provide notifications to a user and a plurality of notification event types may incorporate embodiments of the present invention.

FIG. 7B is a block diagram illustrating components of a mobile computing device used in one embodiment, such as the computing device shown in FIG. 7A. That is, mobile computing device 700 can incorporate system 702 to implement some embodiments. For example, system 702 can be used in implementing a “smart phone” that can run one or more applications similar to those of a desktop or notebook computer such as, for example, browser, e-mail, scheduling, instant messaging, and media player applications. In some embodiments, system 702 is integrated as a computing device, such as an integrated personal digital assistant (PDA) and wireless phone.

One or more application programs 766 may be loaded into memory 762 and run on or in association with operating system 764. Examples of application programs include phone dialer programs, e-mail programs, PIM (personal information management) programs, word processing programs, spreadsheet programs, Internet browser programs, messaging programs, and so forth. System 702 also includes non-volatile storage 768 within memory 762. Non-volatile storage 768 may be used to store persistent information that should not be lost if system 702 is powered down. Applications 766 may use and store information in non-volatile storage 768, such as e-mail or other messages used by an e-mail application, and the like. A synchronization application (not shown) also resides on system 702 and is programmed to interact with a corresponding synchronization application resident on a host computer to keep the information stored in non-volatile storage 768 synchronized with corresponding information stored at the host computer. As should be appreciated, other applications may be loaded into memory 762 and run on the device 700, including an indexing application 620, described herein.

System 702 has a power supply 770, which may be implemented as one or more batteries. Power supply 770 might further include an external power source, such as an AC adapter or a powered docking cradle that supplements or recharges the batteries.

System 702 may also include a radio 772 that performs the function of transmitting and receiving radio frequency communications. Radio 772 facilitates wireless connectivity between system 702 and the “outside world”, via a communications carrier or service provider. Transmissions to and from radio 772 are conducted under control of OS 764. In other words, communications received by radio 772 may be disseminated to application programs 766 via OS 764, and vice versa.

Radio 772 allows system 702 to communicate with other computing devices, such as over a network. Radio 772 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

This embodiment of system 702 is shown with two types of notification output devices; LED 720 that can be used to provide visual notifications and an audio interface 774 that can be used with speaker 725 to provide audio notifications. These devices may be directly coupled to power supply 770 so that when activated, they remain on for a duration dictated by the notification mechanism even though processor 760 and other components might shut down for conserving battery power. LED 720 may be programmed to remain on indefinitely until the user takes action to indicate the powered-on status of the device. Audio interface 774 is used to provide audible signals to and receive audible signals from the user. For example, in addition to being coupled to speaker 725, audio interface 774 may also be coupled to a microphone to receive audible input, such as to facilitate a telephone conversation. In accordance with embodiments of the present invention, the microphone 720 may also serve as an audio sensor to facilitate control of notifications, as will be described below. System 702 may further include video interface 776 that enables an operation of on-board camera 730 to record still images, video stream, and the like.

A mobile computing device implementing system 702 may have additional features or functionality. For example, the device may also include additional data storage devices (removable and/or non-removable) such as, magnetic disks, optical disks, or tape. Such additional storage is illustrated in FIG. 7B by storage 768. Computer storage media may include volatile and nonvolatile, removable and non-removable media implemented in any method or technology for storage of information, such as computer readable instructions, data structures, program modules, or other data.

Data/information generated or captured by the device 700 and stored via the system 702 may be stored locally on the device 700, as described above, or the data may be stored on any number of storage media that may be accessed by the device via the radio 772 or via a wired connection between the device 700 and a separate computing device associated with the device 700, for example, a server computer in a distributed computing network, such as the Internet. As should be appreciated such data/information may be accessed via the device 700 via the radio 772 or via a distributed computing network. Similarly, such data/information may be readily transferred between computing devices for storage and use according to well-known data/information transfer and storage means, including electronic mail and collaborative data/information sharing systems.

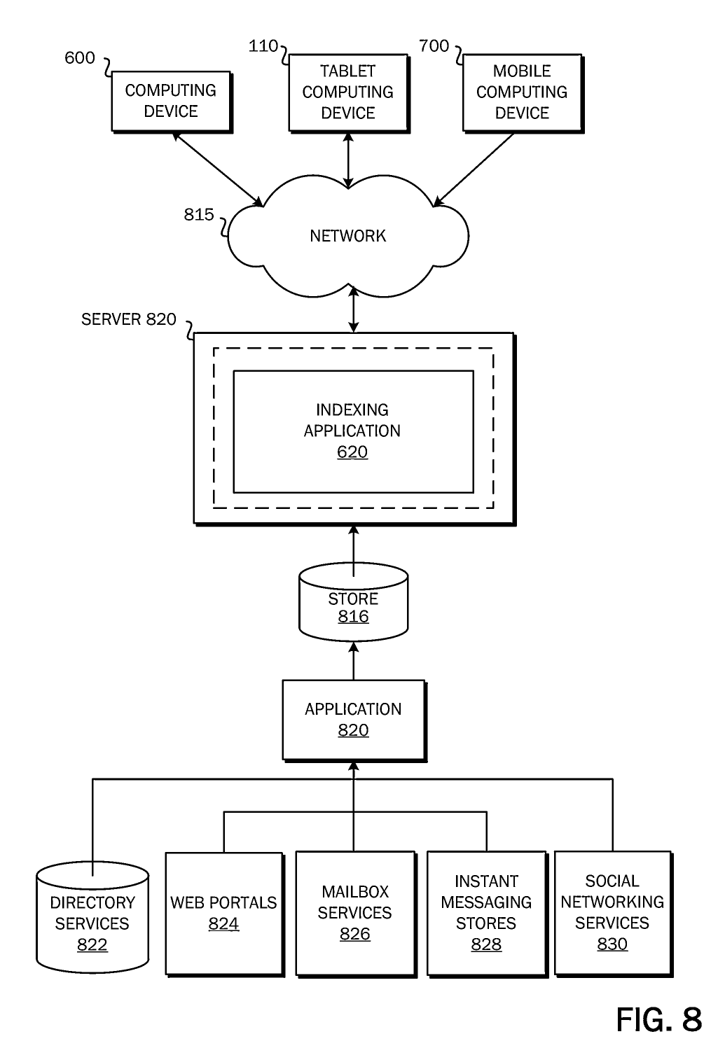

FIG. 8 illustrates a system architecture for providing dynamically generated indices, as described above. Content developed, interacted with or edited in association with an indexing application 620 may be stored in different communication channels or other storage types. For example, various content items along with information from which they are developed may be stored using directory services 822, web portals 824, mailbox services 826, instant messaging stores 828 and social networking sites 830. The indexing application 620 may use any of these types of systems or the like for enabling dynamically generated indices, as described herein. A server 820 may provide content items to clients. As one example, server 820 may be a web server providing content over the web. Server 820 may provide content over the web to clients through a network 815. Examples of clients that may obtain content include computing device 600, which may include any general purpose personal computer 600, a tablet computing device 110 and/or mobile computing device 600 which may include smart phones. Any of these devices may obtain content from the store 816.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

It will be apparent to those skilled in the art that various modifications or variations may be made in the present invention without departing from the scope or spirit of the invention. Other embodiments of the invention will be apparent to those skilled in the art from consideration of the specification and practice of the invention disclosed herein.

We claim:

1. A method for providing a dynamically generated list index, the method comprising:
receiving a list, the list comprising a plurality of data elements ordered according to a value;
generating an index associated with the list, the index comprising a plurality of index groupings;
evenly dividing the plurality of data elements of the list into the plurality of index groupings;
receiving an indication of a modification to the list;
regenerating the index, the regenerated index being associated with the modified list; and
evenly dividing the plurality of data elements of the modified list into a plurality of regenerated index groupings.

2. The method of claim 1, wherein evenly dividing the plurality of data elements of the modified list into the plurality of regenerated index groupings further comprises evenly dividing the plurality of data elements of the modified list into the plurality of regenerated index groupings, the plurality of regenerated index groupings being limited to a fixed number of index groupings.

3. The method of claim 2, further comprising performing a calculation to evenly divide the plurality of data elements of the modified list into the fixed number of index groupings.

4. The method of claim 1, wherein evenly dividing the plurality of data elements of the modified list into the plurality of regenerated index groupings further comprises evenly dividing the plurality of data elements of the modified list into the plurality of regenerated index groupings, the plurality of regenerated index groupings comprising a fixed limit on a number of data elements per index grouping.

5. The method of claim 4, further comprising performing a calculation to evenly divide the plurality of data elements of the modified list into the plurality of index groupings, the number of data elements in each of the plurality of index groupings being constrained by the fixed limit of data elements per index grouping.

6. The method of claim 1, wherein receiving an indication of a modification to the list includes receiving an indication of an addition of one or more data elements.

7. The method of claim 1, wherein receiving an indication of a modification to the list includes receiving an indication of a removal of one or more data elements.

8. The method of claim 1, wherein receiving an indication of a modification to the list includes receiving an indication of change to one or more data elements.

9. The method of claim 1, wherein receiving a list, the list comprising a plurality of data elements ordered according to a value includes data elements ordered alphabetically.

10. The method of claim 1, wherein receiving a list, the list comprising a plurality of data elements ordered according to a value includes data elements ordered numerically.

11. The method of claim 1, wherein generating an index associated with the list, the index comprising a plurality of index groupings further comprises generating a plurality of index grouping entry points representing the plurality of index groupings.

12. The method of claim 11, further comprising regenerating the plurality of index grouping entry points upon receiving an indication of a modification to the list.

13. A system for providing a dynamically generated list index, the system comprising an indexing application operable to:
receive a list, the list comprising a plurality of data elements ordered according to a value;
generate an index associated with the list, the index comprising a plurality of index groupings;
evenly distribute the plurality of data elements of the list into the plurality of index groupings, each index grouping comprising no more than a specified number of data elements per index grouping;
receive an indication of a modification to the list;
regenerate the index, the regenerated index being associated with the modified list; and
evenly distribute the plurality of data elements of the modified list into a plurality of regenerated index groupings, each of the plurality of regenerated index groupings comprising no more than the specified number of data elements per index grouping.

14. The system of claim 13, wherein the indication of a modification to the list includes one or more of an indication of an addition of one or more data elements, an indication of a removal of one or more data elements, or an indication of a change to one or more data elements.

15. The system of claim 13, the indexing application being further operable to perform a calculation to evenly distribute the plurality of data elements of the list into the plurality of regenerated index groupings, each regenerated index grouping comprising no more than the specified number of data elements per index grouping.

16. The system of claim 13, wherein the list comprising a plurality of data elements ordered according to a value includes data elements ordered alphabetically..

17. The system of claim 13, wherein the list comprising a plurality of data elements ordered according to a value includes data elements ordered numerically.

18. The system of claim 13, wherein the indexing application is further operable to generate a plurality of selectable index grouping entry points, each of the plurality of selectable index grouping entry points corresponding to each the plurality of index groupings, and wherein upon selection of a selectable index grouping entry point, the corresponding index grouping is accessed.

19. A computer readable medium containing computer-executable instructions which when executed by a computer perform a method for providing a dynamically generated index, the method comprising:
receiving a list, the list comprising a plurality of data elements ordered according to a value;
generating an index associated with the list, the index comprising a specified number of index groupings and index grouping entry points corresponding to each of the index groupings;
evenly dividing the plurality of data elements of the list into the specified number of index groupings;
receiving an indication of a modification to the list, the modification including one or more of an addition of one or more data elements, a removal of one or more data elements, or a change to one or more data elements;
regenerating the index, the regenerated index being associated with the modified list;
evenly dividing the plurality of data elements of the modified list into the specified number of index groupings; and
regenerating the index grouping access points to correspond with the index groupings of the regenerated index.

20. The computer readable medium of claim 19, wherein evenly dividing the plurality of data elements of the list into the specified number of index groupings includes performing a calculation to determine a number of data elements per index grouping for an even distribution of data elements.
